(19) United States
(12) Patent Application Publication
(10) Pub. No.: US 2009/0162484 A1
(43) Pub. Date: Jun. 25, 2009

(54) BEVERAGE HAVING A NON-SWEETENING AMOUNT OF A POTENT NATURAL SWEETENER

(75) Inventors: Zena Bell, Hartsdale, NY (US); Thomas Lee, Scarsdale, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Concentrate Manufacturing Company of Ireland, Hamilton (BM)

(21) Appl. No.: 11/962,258

(22) Filed: Dec. 21, 2007

(51) Int. Cl. A23L 1/236; C12G 3/00; A23F 5/00; A23F 3/00; A23L 2/02; A23C 9/00; A23L 2/56; A23L 2/385

(52) U.S. Cl. 426/66; 426/590; 426/592; 426/594; 426/597; 426/599; 426/580; 426/548

(57) ABSTRACT

Beverage products including a non-sweetening amount of a potent natural sweetener are provided. Beverage concentrate compositions including a non-sweetening amount of a potent natural sweetener are also provided.

### TECHNICAL FIELD

This invention relates to beverages and other beverage products, such as beverage concentrates, etc. In particular, this invention relates to beverages and other beverage products having formulations suitable to meet market demand for alternative nutritional characteristics, taste characteristics and/or mouthfeel characteristics.

### BACKGROUND

It has long been known to produce beverages of various formulations. Improved and new formulations are desirable to meet changing market demands. In particular, there is perceived market demand for beverages having alternative flavor profiles, including good taste, mouthfeel, etc. In particular, there is perceived market demand for beverage products having alternative taste characteristics, including, for example, accentuation of flavor impact.

It is therefore an object of the present invention to provide beverage products having a non-sweetening amount of a potent natural sweetener. It is an object of at least certain embodiments of the invention to provide beverage products having formulations incorporating a non-sweetening amount of one or more potent sweeteners, e.g., steviol glycosides, Lo Han Guo, mogroside V, monatin, and/or glycyrrhizin and being suitable to meet market demand for alternative flavor profiles in beverage products. It is an object of at least certain embodiments of the invention to provide a non-sweetening amount of one or more potent sweeteners, e.g., steviol glycosides, Lo Han Guo, mogroside V, monatin, and/or glycyrrhizin that can be used to impart one or more desirable taste characteristics to a beverage product described here. These and other objects, features and advantages of the invention or of certain embodiments of the invention will be apparent to those skilled in the art from the following disclosure and description of exemplary embodiments.

### SUMMARY

In at least certain exemplary embodiments, the beverage products disclosed here are based at least in part on the discovery of novel combinations of a beverage product having water and a non-sweetening amount of one or more potent natural sweeteners (such as, e.g., rebaudioside A, stevioside, morgroside V, monatin and/or glycyrrhizin) that can be used to modify the taste of a beverage product.

It has been discovered that a non-sweetening amount of a potent natural sweetener can modify the taste of beverage products, causing an increase in desirable taste characteristics such as, for example, one or both of accentuation of flavor impact and enhanced sweetness. It has also been discovered that a non-sweetening amount of a potent natural sweetener can cause a decrease in undesirable taste characteristics in beverage products such as, for example, bitterness, sourness, off-flavor or any combination thereof. It has also been discovered that a non-sweetening amount of a potent natural sweetener can cause a decrease in undesirable mouthfeel characteristics in beverage products such as, for example, oiliness, sliminess, cling, chalkiness or any combination thereof.

In accordance with a first aspect, beverage products include water and a non-sweetening amount of at least one potent natural sweetener. In certain exemplary embodiments, the at least one potent natural sweetener includes a steviol glycoside such as, for example, one or more of rebaudioside A and stevioside. In certain exemplary embodiments, the at least one potent natural sweetener includes one or more of mogroside V, monatin, and glycyrrhizin. In certain exemplary embodiments, the beverage is a full calorie beverage, a diet beverage, a zero calorie beverage or a reduced calorie beverage. In certain exemplary embodiments, the beverage is a carbonated soft drink or a non-carbonated soft drink. In certain exemplary embodiments, the beverage is an energy beverage, a hydration beverage, a health and wellness beverage, a fountain beverage, a frozen ready-to-drink beverage, a coffee beverage, a tea beverage, a dairy beverage, a flavored water, an enhanced water, a fruit juice, a fruit juice-flavored beverage, a sport beverage or an alcoholic beverage. In certain exemplary embodiments, the beverage includes one or more of at least one tea, at least one coffee, at least one dairy product and at least one juice. In certain exemplary embodiments, the non-sweetening amount of at least one potent natural sweetener provides one or more of an increase of at least one desirable taste characteristic, a decrease of at least one undesirable taste characteristic and a decrease of at least one undesirable mouthfeel characteristic. In certain exemplary embodiments, the at least one desirable taste characteristic includes one or both of accentuation of flavor impact and enhanced sweetness. In certain exemplary embodiments, the beverage product further includes a sweetening amount of one or more of at least one additional potent natural sweetener, at least one potent artificial sweetener and at least one nutritive sweetener. In certain exemplary embodiments, the non-sweetening amount of at least one potent natural sweetener is present at a concentration of about 100 PPM or less, at a concentration of about 10 PPM to 50 PPM, at a concentration of about 20 PPM to 60 PPM or at a concentration of about 40 PPM to 80 PPM. In certain exemplary embodiments, the beverage product further includes at least one additional component selected from at least one taste modifier, a sweetening amount of at least one additional potent natural sweetener, sweetening amount of at least one potent artificial sweetener, sweetening amount of at least one nutritive natural sweetener, at least one natural flavoring and at least one artificial flavoring. In certain exemplary embodiments, the sweetening amount of at least one nutritive natural sweetener includes one or both of glucose-fructose syrup and sucrose. In certain exemplary embodiments, the sweetening amount of at least one potent artificial sweetener includes one or more of aspartame, Acesulfame K, saccharine, neotame and sucralose. In certain exemplary embodiments, the at least one natural flavoring includes one or more of at least one cola flavor, at least one fruit flavor, at least one tea flavor, at least one coffee flavor and at least one herb flavor.

In accordance with a second aspect, beverage concentrates include a non-sweetening amount of at least one potent natural sweetener. In certain exemplary embodiments, a full strength beverage is produced by diluting the beverage concentrate with water. In certain exemplary embodiments, the full strength beverage includes one part beverage concentrate and five parts water.

It will be appreciated by those skilled in the art, given the benefit of the following description of certain exemplary embodiments of the beverage and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION

The present invention provides beverage products having non-sweetening amounts of one or more natural sweeteners, for example, a potent natural sweetener. It should be understood that beverages and other beverage products in accordance with this disclosure may have any of numerous different specific formulations or constitutions. The formulation of a beverage product in accordance with this disclosure can vary to a certain extent, depending upon such factors as the product's intended market segment, its desired nutritional characteristics, flavor profile and the like. For example, it will generally be an option to add further ingredients to the formulation of a particular beverage embodiment, including any of the beverage formulations described below.

As used herein, the term “non-sweetening amount” refers to an amount of a sweetener that, in the beverage product as a whole, is not perceptible as sweet as judged by a majority of persons that have tasted a sample containing the non-sweetening amount of sweetener. In certain exemplary embodiments, the beverage product is not perceptibly sweetened by a low amount of potent natural sweetener included in the formulation of the product. In other exemplary embodiments, a non-sweetening amount of a potent natural sweetener may enhance the inherent sweetness of a beverage product, as discussed further herein. Also, in certain exemplary embodiments, a non-sweetening amount of a potent natural sweetener can modify the taste of the beverage product by decreasing or eliminating one or more undesirable taste characteristics, decreasing one or more undesirable mouthfeel characteristics, increasing one or more desirable taste characteristics or any combination of these. As used herein, the terms increasing, decreasing, accentuating, and enhancing of a taste or mouthfeel characteristic means perceptibly changing that characteristic compared with the perceptible level of that characteristic in a correspondingly formulated beverage product that does not include a non-sweetening amount of a natural potent sweetener.

As used herein, the term “taste” refers to the flavor of the beverage product and includes sweetness, sourness, bitterness, saltiness and umami (e.g., savoriness or meatiness). As used herein, the term “mouthfeel” refers to a tactile sensation a beverage product gives to the mouth (i.e., due to physical and chemical interactions in the mouth). Mouthfeel is evaluated from initial perception on the palate through to swallowing. Mouthfeel and taste may overlap and/or impact each other.

As used herein, the term “undesirable taste characteristic” refers to one or more off-flavors that can be perceived in beverage products. Undesirable taste characteristics are known in the art and include, for example, but are not limited to, bitterness, sourness, off-flavor and any combination thereof.

As used herein, the term “undesirable mouthfeel characteristic” refers to one or more unwanted tactile sensations that can be perceived in beverage products. Undesirable mouthfeel characteristics are known in the art and include, for example, but are not limited to, oiliness, sliminess, cling, chalkiness, and any combination thereof.

As used herein, the term “desirable taste characteristic” refers to one or more attractive flavors or tastes that can be added to beverage products described here. Desirable taste characteristics are known in the art and include, for example, but are not limited to, one or both of accentuation of flavor impact (e.g., flavor perception when eaten) and enhanced sweetness. In certain exemplary embodiments, a non-sweetening amount of a potent natural sweetener reduces or eliminates the need for additional flavor enhancers discussed further herein.

In certain exemplary embodiments the non-sweetening amount of at least one potent natural sweetener in a beverage product modifies the taste of the beverage product but does not by itself contribute perceptible sweetness. In certain exemplary embodiments, a non-sweetening amount of a potent natural sweetener such as, for example, at least one of rebaudioside A, stevioside, mogroside V, monatin, glycyrrhizin, etc., is typically an amount between about 1 PPM and about 100 PPM of the beverage product. In certain exemplary embodiments, the non-sweetening amount of a potent natural sweetener is between about 20 PPM and about 60 PPM, between about 40 PPM and about 80 PPM or between about 10 PPM and about 50 PPM. In certain exemplary embodiments, the non-sweetening amount of a potent natural sweetener in a carbonated soft drink is, for example, between about 20 PPM and about 60 PPM. In certain exemplary embodiments, the non-sweetening amount of a potent natural sweetener in a hydration beverage is, for example, between about 20 PPM and about 60 PPM. In certain exemplary embodiments, the non-sweetening amount of a potent natural sweetener in a tea beverage is, for example, between about 40 PPM and about 80 PPM. In certain exemplary embodiments, the non-sweetening amount of a potent natural sweetener in a juice beverage is, for example, between about 10 PPM and about 50 PPM. In certain exemplary embodiments, the non-sweetening amount of a potent natural sweetener in a dairy beverage is, for example, between about 10 PPM and about 50 PPM.

The non-sweetening amount of potent natural sweetener used will depend upon the desired level of taste modification (such as, for example, the degree and amount of increase in sweetness effect of a sweetener present in a sweetening amount and/or flavor perception and/or a decrease in undesirable taste characteristic(s) or undesirable mouthfeel characteristic(s)) for the beverage product. The non-sweetening amount of a potent natural sweetener used will also depend on the particular potent natural sweetener used as they may differ in the ability to modify the taste of the beverage product when used in non-sweetening amounts.

As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a beverage product sweetened to a level of 10 degrees Brix with sugar. Potent sweeteners include both nutritive and non-nutritive sweeteners. In addition, potent sweeteners include both potent natural sweeteners and artificial potent sweeteners. Commonly accepted potency figures for certain potent sweeteners include, for example,

| | | |
|---|---|---|
| Cyclamate | 30 | times as sweet as sugar |
| Glycyrrhizin | 30-50 | times as sweet as sugar |
| Stevioside | 100-250 | times as sweet as sugar |
| Mogroside V | 100-300 | times as sweet as sugar |
| Rebaudioside A | 150-300 | times as sweet as sugar |
| Acesulfame-K | 200 | times as sweet as sugar |
| Aspartame | 200 | times as sweet as sugar |
| Saccharin | 300 | times as sweet as sugar |
| Neohesperidin dihydrochalcone | 300 | times as sweet as sugar |
| Sucralose | 600 | times as sweet as sugar |
| Alitame | 2,000 | times as sweet as sugar |
| Neotame | 8,000 | times as sweet as sugar |

As used herein, the term “nutritive sweetener” refers generally to sweeteners which provide significant caloric content in typical usage amounts, e.g., more than about 5 calories per 8 oz. serving of beverage. As used herein, a “non-nutritive sweetener” is one which does not provide significant caloric content in typical usage amounts, i.e., is one which imparts less than 5 calories per 8 oz. serving of beverage to achieve the sweetness equivalent of 10 Brix of sugar. As used herein, a “full-calorie” beverage formulation is one fully sweetened with a nutritive sweetener. As used herein, “reduced calorie beverage” means a beverage having at least a 25% reduction in calories per 8 oz. serving of beverage as compared to the full calorie version, typically a previously commercialized full-calorie version. As used herein, a “low-calorie beverage” has fewer than 40 calories per 8 oz. serving of beverage. As used herein, a “zero-calorie beverage” or “diet beverage” means having less than 5 calories per serving, e.g., per 8 oz. for beverages.

As used herein, the term “natural” is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR §170.3(o)(24)) are considered incidental additives and may be used if removed appropriately. As used herein, the term “artificial” is anything that is not natural, e.g., anything that is made by man.

The sweetener(s) used in the beverage products disclosed here are edible consumables suitable for consumption in beverages. By “edible consumables” is meant a food or beverage or an ingredient of a food or beverage for human or animal consumption. The sweetener or sweetening agent, as those terms are used here, can be a nutritive or non-nutritive, natural or artificial beverage product ingredient or additive (or mixtures of them) which is capable of providing sweetness to the beverage product in when used in sweetening amounts. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent in any given product may involve the interrelationship of elements.

In certain exemplary embodiments, the non-sweetening amount of a potent natural sweetener of the beverage products disclosed here may be, for example, any one or more of the steviosides, rebaudiosides and related compounds suitable for sweetening. These compounds can be obtained by extraction or the like from the Stevia plant. Stevia (e.g., Stevia rebaudiana bectoni) is a sweet-tasting plant, whose leaves contain a complex mixture of natural sweet diterpene glycosides (e.g., steviol glycosides). Steviosides and rebaudiosides are components of Stevia that contribute sweetness. Typically, these compounds are found to include stevioside (4-13% dry weight), steviolbioside (trace), the rebaudiosides, including rebaudioside A (2-4%), rebaudioside B (trace), rebaudioside C (1-2%), rebaudioside D (trace), and rebaudioside E (trace), and dulcoside A (0.4-0.7%). Such compounds are referred to herein as Stevia components.

In certain exemplary embodiments, the non-sweetening amount of a potent natural sweetener of the beverage products disclosed here may be, for example, the non-nutritive, potent sweetener Lo Han Guo. Lo Han Guo has various different spellings and pronunciations, can be obtained from fruit of the plant family Cucurbitaceae, tribe Jollifieae, subtribe Thladianthinae, genus Siraitia. Lo Han Guo often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Lo Han Guo fruit. Lo Han Guo contains triterpene glycosides or mogrosides (e.g., mogroside V), which constituents may be used as Lo Han Guo sweeteners. Lo Han Guo can be used as the juice or juice concentrate, powder, etc. In certain exemplary embodiments, Lo Han Guo juice contains at least about 0.1%, e.g., from 0.1% to about 15%, mogrosides, such as mogroside V, mogroside IV, 11-oxo-mogroside V, siamenoside and mixtures thereof. LHG can be produced, for example, as discussed in U.S. Pat. No. 5,411,755.

Sweeteners from other fruits, vegetables or plants also may be used as natural or processed sweeteners or sweetness enhancers in at least certain exemplary embodiments of the beverage products disclosed here comprising at least a non-sweetening amount pf a potent natural sweetener.

In certain exemplary embodiments, beverage products may include, in addition to the non-sweetening amount of one or more potent natural sweeteners, a sweetening amount of one or more natural or artificial sweeteners. As used herein, the term “sweetening amount” refers to an amount of a sweetener that, in the beverage product as a whole, is perceptible as sweet as judged by a majority of persons that have tasted a sample containing the sweetening amount of sweetener. A sweetening amount of a sweetener, when given a numerical value, can be determined on the basis of the sweetness of a 7% by weight aqueous solution of sucrose. This technique is well known to those skilled in the art and is seen, for example, in U.S. Pat. No. 4,902,525. Sweeteners also can affect the mouthfeel, i.e., the body or texture of the beverage. Too much sweetener can overpower other flavors while too little can yield in some cases a beverage that tastes watery or flat.

Sweeteners suitable for use in sweetening amounts in various embodiments of the beverage products disclosed here comprising a non-sweetening amount of a potent natural sweetener include a sweetening amount of, e.g., natural (e.g., additional natural) and artificial or synthetic sweeteners. Sweetening amounts of suitable sweeteners and combinations of sweeteners are selected for the desired nutritional characteristics, taste profile for the beverage product, sweetness and other organoleptic factors. Sweeteners suitable for at least certain such exemplary embodiments include a sweetening amount of, for example, one or more of sorbitol, mannitol, xylitol, neohesperidin dihydrochalcone, D-tagatose, erythritol, maltitol, maltose, lactose, fructo-oligosaccharides, acesulfame, aspartame, sucralose, saccharin, xylose, arabinose, isomalt, lactitol, maltitol, trehalose, ribose, protein sweeteners, such as, for example, thaumatin, monellin, brazzein, L-alanine and glycine and any combination thereof.

In certain exemplary embodiments, beverage products having a non-sweetening amount of one or more potent natural sweeteners also employ a sweetening amount of, e.g., nutritive, natural crystalline or liquid sweeteners such as a sweetening amount of, for example, sucrose, fructose, glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others, and mixtures of any of them.

Exemplary artificial sweeteners suitable for use in a sweetening amount as an optional additional sweetener in at least certain embodiments of the beverage products disclosed here include a sweetening amount of, for example, saccharin, cyclamate, aspartame, other dipeptides, acesulfame potassium, and other such potent sweeteners, and mixtures of any of them, as further discussed below. In certain exemplary embodiments, beverage products having a non-sweetening amount of one or more potent natural sweeteners employ, e.g., artificial potent sweeteners. Such artificial potent sweeteners include peptide based sweeteners, for example, acesulfame potassium, aspartame, neotame, and alitame, and non-peptide based sweeteners, for example, sodium saccharin, calcium saccharin, acesulfame potassium, sodium cyclamate, calcium cyclamate, neohesperidin dihydrochalcone, sucralose, and mixtures of any of them. It will be within the ability of those skilled in the art, given the benefit of this disclosure, to select suitable additional or alternative sweeteners for use in a sweetening amount in various embodiments of the beverage products comprising a non-sweetening amount of a potent natural sweetener disclosed here.

Additional (i.e., more and/or other) sweeteners may be added, flavorings, electrolytes, vitamins, fruit juices or other fruit products, taste modifiers, e.g., tastents, masking agents and the like, flavor enhancers, and/or carbonation typically can be added to any such formulations to vary the taste, mouthfeel, nutritional characteristics, etc. Exemplary flavorings which may be suitable for at least certain formulations in accordance with this disclosure include cola flavoring, citrus flavoring, spice flavorings and others. Carbonation in the form of carbon dioxide may be added for effervescence. Preservatives can be added if desired, depending upon the other ingredients, production technique, desired shelf life, etc. Optionally, caffeine can be added. Certain exemplary embodiments of the beverages comprising at least a non-sweetening amount of a potent natural sweetener disclosed here are cola-flavored carbonated beverages, characteristically containing carbonated water, sweetener, kola nut extract and/or other flavoring, caramel coloring, phosphoric acid, and optionally other ingredients. Additional and alternative suitable ingredients will be recognized by those skilled in the art given the benefit of this disclosure.

The beverage products disclosed here include beverages, i.e., ready-to-drink liquid formulations, beverage concentrates and the like. Beverages include, e.g., carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sport drinks, energy drinks, hydration drinks (e.g., GATORADE™), health and wellness drinks and alcoholic beverages. Beverages further include, e.g., full calorie drinks/beverages and reduced-calorie (e.g., diet) drinks/beverages. Beverage products may include at least one of tea, coffee, dairy product, and juice.

The terms “beverage concentrate” and “syrup” are used interchangeably throughout this disclosure. At least certain exemplary embodiments of the beverage concentrates contemplated are prepared with an initial volume of water to which the additional ingredients are added. Full strength beverage compositions can be formed from the beverage concentrate by adding further volumes of water to the concentrate such that the concentrate is diluted to a full strength beverage. Typically, for example, full strength beverages can be prepared from the concentrates by combining approximately 1 part concentrate with between approximately 3 to approximately 7 parts water. In certain exemplary embodiments the full strength beverage is prepared by combining 1 part concentrate with 5 parts water. In certain exemplary embodiments the additional water used to form the full strength beverages is carbonated water. In certain other embodiments, a full strength beverage is directly prepared without the formation of a concentrate and subsequent dilution.

Those of ordinary skill in the art will understand that, for convenience, some ingredients are described here in certain cases by reference to the original form of the ingredient in which it is used in formulating or producing the beverage product. Such original form of the ingredient may differ from the form in which the ingredient is found in the finished beverage product. Thus, for example, in certain exemplary embodiments of the beverage products according to this disclosure, a non-sweetening amount of one or more potent sweeteners would typically be substantially homogenously dissolved and dispersed in the beverage. Likewise, other ingredients identified as a solid, concentrate (e.g., juice concentrate), etc. would typically be homogenously dispersed throughout the beverage or throughout the beverage concentrate, rather than remaining in their original form. Thus, reference to the form of an ingredient of a beverage product formulation should not be taken as a limitation on the form of the ingredient in the beverage product, but rather as a convenient means of describing the ingredient as an isolated component of the product formulation.

Water is a basic ingredient in the beverage products disclosed here, comprising a non-sweetening amount of one or more potent sweeteners, typically being the vehicle or liquid portion in which the remaining ingredients are dissolved, emulsified, suspended or dispersed. Purified water can be used in the manufacture of certain embodiments of the beverage product, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain exemplary embodiments, water is present at a level of from about 80% to about 99.9% by weight of the full strength beverage.

In at least certain exemplary embodiments the water used in beverages and concentrates disclosed here is “treated water,” which refers to water that has been treated to remove substantially all mineral content of the water prior to optional supplementation with any of the components described herein as disclosed in U.S. Pat. No. 7,052,725. Methods of producing treated water are known to those of ordinary skill in the art and include deionization, distillation, filtration and reverse osmosis (“R—O”), among others. The terms “treated water,” “purified water,” “demineralized water,” “distilled water,” and “R—O water” are understood to be generally synonymous in this discussion, referring to water from which substantially all mineral content has been removed, typically containing no more than about 500 ppm total dissolved solids, e.g., no more than about 250 ppm.

Certain embodiments of the beverage products disclosed here comprising at least a non-sweetening amount of a potent natural sweetener also include one or more acids. An acidulant can serve any of one or more functions, including, for example, lending tartness to the taste of the beverage, enhancing palatability, increasing thirst quenching effect, modifying sweetness and acting as a mild preservative. Suitable acids are known and will be apparent to those skilled in the art given the benefit of this disclosure. Exemplary acids suitable for use in some or all embodiments of the beverages comprising at least a non-sweetening amount of a potent natural sweetener disclosed here include phosphoric acid, citric acid, malic acid, tartaric acid, lactic acid, formic acid, ascorbic acid, hydrochloric acid, sulfuric acid, fumaric acid, gluconic acid, succinic acid, maleic acid and adipic acid and mixtures of any of them.

The acid can be used in solution form, for example, and in an amount sufficient to provide the desired pH of the beverage. Typically, for example, the one or more acids of the acidulant are used in amount, collectively, of from about 0.01% to about 0.5% by weight of the beverage, e.g., from about 0.05% to about 0.25% by weight of the beverage, depending upon the acidulant used, desired pH, other ingredients used, etc. The pH of at least certain exemplary embodiments of the beverages disclosed here comprising at least a non-sweetening amount of a potent natural sweetener can be a value within the range of from about 2.0 to about 5.0. The acid in certain exemplary embodiments enhances beverage flavor. Too much acid can impair the beverage flavor and result in sourness or other off-taste, while too little acid can make the beverage taste flat.

The particular acid or acids chosen and the amount used will depend, in part, on the other ingredients, the desired shelf life of the beverage product, as well as effects on the beverage pH, titratable acidity, and taste. Those skilled in the art, given the benefit of this disclosure, will recognize that when preparing beverage products containing peptide-based artificial sweeteners such as aspartame, the resulting beverage composition is best maintained below a certain pH to retain the sweetening effect of the artificial sweetener. In the formation of calcium-supplemented beverages, the presence of calcium salts increases the pH which requires additional acids to both assist the dissolution of the salt and maintain a desirable pH for stability of the artificial sweetener. The presence of the additional acid in the beverage composition, which increases the titratable acidity of the composition, will result in a more tart or sour taste to the resulting beverage. It will be within the ability of those skilled in the art, given the benefit of this disclosure, to select a suitable acid or combination of acids and the amounts of such acids for the acidulant component of any particular embodiment of the beverages comprising at least a non-sweetening amount of a potent natural sweetener disclosed here.

Certain exemplary embodiments of the beverage products disclosed here comprising at least a non-sweetening amount of a potent natural sweetener also may contain small amounts of alkaline agents to adjust pH. Such agents include, e.g., potassium hydroxide, sodium hydroxide and potassium carbonate. For example, the alkaline agent potassium hydroxide may be used in an amount of from about 0.02 to about 0.04% by weight, with an amount of about 0.03% being typical for certain beverages. The amount will depend on the type of alkaline agents and on the degree to which the pH is to be adjusted.

The beverage products disclosed here comprising at least a non-sweetening amount of a potent natural sweetener optionally contain one or more additional flavor compositions, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. Also included within the term “fruit flavor” are synthetically prepared flavors made to simulate fruit flavors derived from natural sources. Examples of suitable fruit sources include whole fruits or portions thereof, fruit juice, fruit juice concentrates, fruit purees and blends thereof, dried fruit powders, dried fruit juice powders, freeze dried fruit juices, powders and purees and the like.

Exemplary fruit flavors include the citrus flavors, e.g., orange, mandarin orange, tangerine, tangelo, pomelo, lemon, lime and grapefruit, and such flavors as apple, grape, cherry, and pineapple flavors and the like, and any combination thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component can further comprise a blend of various of the above-mentioned flavors. In certain exemplary embodiments of the beverage concentrates and beverages described here, a cola flavor component and/or a tea flavor component is used. The particular amount of the flavor component useful for imparting flavor characteristics to the beverages comprising at least a non-sweetening amount of a potent natural sweetener disclosed here will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

In certain exemplary embodiments, the beverage products comprising at least a non-sweetening amount of a potent natural sweetener disclosed here can be provided in the form of juice. Juices can be employed in the form of a concentrate, puree, single-strength juice, or other suitable forms. The term “juice” as used here includes single-strength fruit and/or or vegetable juice, as well as concentrates, purees, milks, and other forms. Multiple different fruit and/or vegetable juices can be combined, optionally along with other flavorings, to generate a beverage having the desired flavor. Examples of suitable juice sources include, but are not limited to, plum, prune, fig, pineapple, peach, banana, apple, pear, guava, apricot, coconut, olive, kiwi, quince, buckthorn, passion fruit, rowan, pomegranate, persimmon, mango, rhubarb, papaya, litchi, lemon, orange, lime, tangerine, mandarin orange, tangelo, pomelo, grapefruit, Barbados cherry (acerola cherry), bearberry, blackberry, blueberry, boysenberry, cherry, choke cherry, cloudberry, cranberry, current, date, dewberry, elderberry, grape, gooseberry, huckleberry, loganberry, olallieberry, mulberry, raisin, plains berry, prairie berry, raspberry, Saskatoon berry, salmonberry, Seabuckthorn berry, sloe berry, strawberry, thimbleberry, Thomberry, wineberry, whortleberry and the like. Numerous additional and alternative juices suitable for use in at least certain exemplary embodiments will be apparent to those skilled in the art given the benefit of this disclosure. In beverage products disclosed here employing juice, juice may be used, for example, at a level of at least about 0.2% by weight of the beverage. In certain exemplary embodiments juice is employed at a level of from about 0.2% to about 40% by weight of the beverage. Typically, juice can be used, if at all, in an amount of from about 1% to about 20% by weight.

Certain such juices which are lighter in color can be included in the formulation of certain exemplary embodiments to adjust the flavor and/or increase the juice content of the beverage without darkening the beverage color. Examples of such juices include apple, pear, pineapple, peach, lemon, lime, orange, mandarin orange, tangelo, pomelo, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Weighting agents, which can also act as clouding agents, are typically used to keep the emulsion droplets dispersed in the beverage. Examples of such weighting agents are brominated vegetable oils, rosin esters and, in particular, ester gums. Any weighting agent that is commercially available can be used in beverages comprising at least a non-sweetening amount of a potent natural sweetener disclosed here. Besides weighting agents, emulsifiers and emulsion stabilizers can be used to stabilize the flavor emulsion droplets. Examples of such emulsifiers and emulsion stabilizers include gums, pectins, cellulose, polysorbates, sorbitan esters and propylene glycol alginates.

Carbon dioxide is used to provide effervescence to certain exemplary embodiments of the beverage products disclosed here. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 7.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage. The carbonation can be natural or synthetic.

Optionally, caffeine can be added to various embodiments of the beverages comprising at least a non-sweetening amount of a potent natural sweetener disclosed here. The amount of caffeine added is determined by the desired beverage properties, any applicable regulatory provisions of the country where the beverage is to be marketed, etc. The caffeine must be of a purity acceptable for use in foods and beverages. The caffeine can be natural (e.g., from kola, cocoa nuts, coffee and/or tea) or synthetic in origin. If caffeine is present in the formulation prior to adding additional caffeine (e.g., in coffee or tea beverages), the caffeine present in them should be factored into the percentage of caffeine in the beverage. The amount of caffeine can be from about 0.002% to about 0.05% by weight of the single strength beverage. In certain embodiments, the amount of caffeine is from about 0.005% to about 0.02%. In certain exemplary embodiments caffeine is included at a level of 0.02 percent or less by weight of the beverage. For concentrates or syrups, the caffeine level can be from about 0.006% to about 0.15%. Caffeine levels can be higher, for example, if flavored coffees which have not been decaffeinated are used since these materials contain caffeine naturally.

The beverage products disclosed here may contain additional ingredients, including, generally, any of those typically found in beverage formulations. These additional ingredients, for example, can typically be added to a stabilized beverage concentrate. Examples of such additional ingredients include, but are not limited to, caffeine, caramel and other coloring agents or dyes, antifoaming agents, gums, emulsifiers, tea solids, cloud components, and nutritional supplements.

Examples of nutritional supplement ingredients are known to those of ordinary skill in the art and include, without limitation, vitamins, minerals, herbs or botanicals, amino acids, or essential fatty acids or enzymes, proteases, tissues, organs, glands or portions thereof. Vitamins include, but are not limited to, vitamin A, vitamin D, vitamin E (tocopherol), vitamin C (ascorbic acid), vitamin B₁ (thiamine), vitamin B₂ (riboflavin), vitamin B₃ (niacin), vitamin B₅ (pantothenic acid), vitamin B₆ (pyridoxine), vitamin B₇ (biotin), vitamin B₉ (folic acid), vitamin B₁₂ (cyanocobalamin), vitamin K (naphthoquinone), vitamin D (D₁ (molecular compound of ergocalciferol with lumisterol, 1:1); D₂ (ergocalciferol or calciferol); D₃ (cholecalciferol); D₄ (dihydrotachysterol); D₅ (sitocalciferol)), and combinations thereof. Supplements are typically present in amounts generally accepted under good manufacturing practices and are typically present in amounts between about 1% to about 100% RDV, where such RDV are established. In certain embodiments, the nutritional supplement ingredient(s) may be present in an amount of from about 5% to about 20% RDV, where established.

Beverages comprising at least a non-sweetening amount of a potent natural sweetener disclosed here can optionally further include one or more colorants. As used herein, the “colorant” is intended to mean any compound that imparts color, which includes, but is not limited to natural pigments, synthetic pigment, color additives and mixtures thereof. Natural and artificial colors may be used. One or more FD&C dyes (e.g., yellow #5, blue #2, red #40) and/or FD&C lakes can be used to color beverages comprising at least a non-sweetening amount of a potent natural sweetener disclosed here. Exemplary lake dyes which may be used in beverages comprising at least a non-sweetening amount of a potent natural sweetener disclosed here are the FDA-approved Lake, such as Lake red #40, yellow #6, blue #1, and the like. Additionally, a mixture of FD&C dyes or a FD&C lake dye in combination with other conventional food and food colorants may be used. Other coloring agents, for example, natural agents may be utilized. Non-limiting examples of such other coloring agents include fruit and vegetable juices and/or powders, riboflavin, carotenoids (for example, beta-carotene), tumeric, and lycopenes. The exact amount of coloring agent used will vary, depending on the agents used and the intensity desired in the finished product. Generally, if utilized, the coloring agent should be present at a level of from about 0.0001% to about 0.5%, from about 0.001% to about 0.1%, or from about 0.004% to about 0.1%, by weight or volume of the composition.

Preservatives may be used in at least certain embodiments of the beverage products disclosed here comprising at least a non-sweetening amount of a potent natural sweetener. That is, at least certain exemplary embodiments contain an optional dissolved preservative system. Solutions with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and any combination thereof.

Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of beverage preservation suitable for at least certain exemplary embodiments of the beverage products disclosed here include, e.g., heat treatment or thermal processing steps, such as hot filling and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate.

The contents of all references, patents and published patent applications cited throughout this application are hereby incorporated by reference in their entirety for all purposes. Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A beverage product comprising:
water and a non-sweetening amount of at least one potent natural sweetener.

2. The beverage product of claim 1, wherein the potent natural sweetener comprises at least one of rebaudioside A, stevioside, monatin, mogroside V, and glycyrrhizin.

3. The beverage product of claim 1, wherein the beverage product is a full calorie beverage, a diet beverage, a zero calorie beverage or a reduced calorie beverage.

4. The beverage product of claim 1, wherein the beverage product is a carbonated soft drink or a non-carbonated soft drink.

5. The beverage product of claim 1, wherein the beverage product is an energy drink, a hydration drink, a health and wellness drink, a fountain beverage, a frozen ready-to-drink beverage, a coffee beverage, a tea beverage, a dairy beverage, a flavored water, an enhanced water, a fruit juice, a fruit juice-flavored drink, a sport drink or an alcoholic beverage.

6. The beverage product of claim 1, wherein the beverage product includes at least one tea, at least one coffee, at least one dairy product, at least one juice, or a combination of any of them.

7. The beverage product of claim 1, wherein the non-sweetening amount of at least one potent natural sweetener provides one or more of an increase of at least one desirable taste characteristic, a decrease of at least one undesirable taste characteristic and a decrease of at least one undesirable mouthfeel characteristic.

8. The beverage product of claim 1, wherein the at least one desirable taste characteristic includes one or both of accentuation of flavor impact and enhanced sweetness.

9. The beverage product of claim 1, further comprising a sweetening amount of at least one additional potent natural sweetener, a sweetening amount of at least one potent artificial sweetener, a sweetening amount of at least one nutritive sweetener, or a combination of any of them.

10. The beverage product of claim 1, wherein the non-sweetening amount of at least one potent natural sweetener is about 100 PPM or less.

11. The beverage product of claim 1, wherein the non-sweetening amount of at least one potent natural sweetener is about 10 PPM to 50 PPM.

12. The beverage product of claim 1, wherein the non-sweetening amount of at least one potent natural sweetener is about 20 PPM to 60 PPM.

13. The beverage product of claim 1, wherein the non-sweetening amount of at least one potent natural sweetener is about 40 PPM to 80 PPM.

14. The beverage product of claim 1, further comprising at least one additional component selected from at least one taste modifier, a sweetening amount of at least one additional potent natural sweetener, a sweetening amount of at least one potent artificial sweetener, a sweetening amount of at least one nutritive natural sweetener, at least one natural flavoring, at least one artificial flavoring, or a combination of any of them.

15. The beverage product of claim 14, wherein the sweetening amount of at least one nutritive natural sweetener includes one or both of glucose-fructose syrup and sucrose.

16. The beverage product of claim 14, wherein the sweetening amount of at least one potent artificial sweetener includes one or more of aspartame, acesulfame K, saccharine, neotame and sucralose.

17. The beverage product of claim 14, wherein the natural flavoring includes one or more of at least one cola flavor, at least one fruit flavor, at least one tea flavor, at least one coffee flavor and at least one herb flavor.

18. A beverage concentrate comprising:
an initial volume of water and a non-sweetening amount of at least one potent natural sweetener.

19. A full strength beverage produced by diluting the beverage concentrate of claim 18 with a further volume of water.

20. The full strength beverage of claim 19, comprising one part beverage concentrate and five parts water.
